(19) United States
(12) Patent Application Publication
(10) Pub. No.: US 2017/0369227 A1
(43) Pub. Date: Dec. 28, 2017

(54) BEVERAGE SLEEVE

(71) Applicant: Y Products LLC, Boca Raton, FL (US)

(72) Inventor: Traci L. Metzger, Boca Raton, FL (US)

(21) Appl. No.: 15/634,454

(22) Filed: Jun. 27, 2017

Related U.S. Application Data
(60) Provisional application No. 62/411,974, filed on Oct. 24, 2016.
(60) Provisional application No. 62/355,655, filed on Jun. 28, 2016.

(51) Int. Cl. B65D 81/38; B32B 1/08; B32B 5/02; B32B 7/12; B32B 29/02; B32B 37/12; B32B 37/14; B32B 37/20; A47G 23/02; B32B 38/00

(52) U.S. Cl. CPC B65D 81/3876; A47G 23/0241; A47G 23/0266; A47G 23/0216; B32B 1/08; B32B 5/022; B32B 38/145; B32B 29/02; B32B 37/12; B32B 37/144; B32B 37/20; B32B 38/0004; B32B 7/12; A47G 2023/0291; B32B 2250/02; B32B 2255/12; B32B 2255/26; B32B 2262/02; B32B 2262/062; B32B 2262/065; B32B 2305/28; B32B 2307/304; B32B 2307/7265; B32B 2307/728; B32B 2317/10; B32B 2439/02; B32B 2317/12

(57) ABSTRACT

A beverage sleeve provides a device for a consumer to use in connection with a hot or cold beverage. The sleeve is operable to keep the hot beverage container cool to the touch for the consumer while keeping a cold beverage dry to the touch of the consumer. A method of manufacturing produces the improved sleeve. The sleeve includes marketing opportunities by providing advertising indicia that are interfacable with the consumer and a marketing network.

### CROSS-REFERENCE TO RELATED APPLICATIONS

This application claims priority to U.S. Provisional Patent Application No. 62/355,655 filed Jun. 28, 2016, and U.S. Provisional Patent Application No. 62/411,974, filed Oct. 24, 2016, the contents of which are hereby incorporated in their entirety.

### FIELD OF TECHNOLOGY

The present disclosure pertains to a beverage sleeve and a method for manufacturing the same.

### BACKGROUND

Beverage containers, such as cups, bottles, aluminum cans, and the like, that contain cold beverages often produce condensation on the exterior of the container. The condensation may be uncomfortable to the consumer as it tends to make their hand and clothes wet, as well as the condensation drips onto desks, tables and nearby surfaces. Such condensation may even drip onto nearby papers, electronic devices, for example mobile phones, thereby potentially causing damage to such objects.

To reduce the formation of condensation, and therefore the negative consequences associated therewith, some expensive beverage containers include a construction having a double walled insulation with an air gap therebetween. However, such construction is a built-in feature which makes it a costly beverage container, and therefore this style is not usable as a single-use solution. A single use solution is disposable (with or without the cup) after the single use and sometimes it is recyclable. To account for condensation, some solutions may include paper or paperboard coasters, such as those used in restaurant settings, or napkins. However, the coasters and/or napkins absorb only small amounts of condensation before the material breaks down and therefore are no longer usable as adequate solutions.

There also exist cold beverage insulators in which the beverage containers are inserted to maintain the cold temperature of the beverages contained therein. However, such beverage insulators are generally made of non-absorbent materials, such as leather, neoprene, EVA, polyester, vinyl, canvas, and various open-cell and closed-cell foams, and therefore are ineffective for absorbing the condensation. Such materials also are not environmentally friendly. Further, such beverage insulators generally would not be discarded after a single use, and therefore would not be an ideal solution in settings such as bars, cafes, diners, restaurants, food carts, or wherever else cold drinks may be sold or served.

Beverage insulators are also used with hot beverages. In the hot beverage market, light weight cups are used that have limited thermal resistance thus causing excessive heat transfer. As such they can make the human hand hot and potentially burned due to the heat generated from the liquid that is present in the beverage container to the consumer's hand when holding the beverage container.

To reduce the transfer of heat from a hot beverage that is present in a beverage container and to minimize heat transfer to the consumers skin/hand, current solutions include paper sleeves that have configured paperboard to create air pockets/space between the heat being transferred through the cup and the consumer's hand. Other options are to provide treatments to the paper construction in an attempt to protect a consumer's skin/hand from the heat that flows through the beverage container. Also, Styrofoam, also known as polystyrene, has been used as an insulator for cups that contain hot beverages. However, polystyrene has been cited as being harmful to the environment and potentially causes respiratory issues.

It would be beneficial to provide an improved beverage sleeve that solves the aforementioned problems. It would also be beneficial to provide a unitary beverage sleeve that can keep a consumer's hand cool when a hot beverage is present in a container, yet keep a consumer's hand dry when cold beverages are present in the container as they tend to cause surface condensation buildup. It would also be beneficial to provide a unitary beverage sleeve that is universal in design in that it is selectively adjustable to fit multiple sized cups. The disclosed designs will permit store owners to stock a single sku for a beverage sleeve that fits many size cups for use with both hot and cold beverage applications.

### BRIEF DESCRIPTION OF THE DRAWINGS

Referring now to the drawings, illustrative embodiments are shown in detail. Although the drawings represent some embodiments, the drawings are not necessarily to scale and certain features may be exaggerated, removed, or partially sectioned to better illustrate and explain the present invention. Further, the embodiments set forth herein are not intended to be exhaustive or otherwise limit or restrict the claims to the precise forms and configurations shown in the drawings and disclosed in the following detailed description.

FIG. 1 is an illustration of a beverage container with an improved beverage sleeve positioned around the beverage container;

FIGS. 2 and 3 are perspective views of an exemplary beverage sleeve, showing branding opportunities disposed on a surface of the sleeve;

FIG. 4 is a cross-sectional view of the exemplary beverage sleeve of FIGS. 2 and 3, showing the cross sectional layers of the construction of a sleeve;

FIG. 5 is a schematic flow diagram of an exemplary process for manufacturing the beverage sleeve of FIGS. 2-4;

FIG. 6 is an alternative beverage sleeve that is universal and can be used with the container shown in FIG. 1 or with containers of other sizes, showing an expandable gusset feature;

FIG. 7 is a simplified cross sectional view of the FIG. 6 gusseted sleeve; and

FIG. 8 is a diagram of a new channel for consumer engagement with a beverage sleeve.

### DETAILED DESCRIPTION

An improved, cost-effective solution for handling condensation formation on the exterior of a beverage container is disclosed. The solution further includes an improved beverage sleeve which keeps the consumer's hand dry when a cold beverage is used, yet keeps their hand at normal body temperature when a hot beverage is used, so as to generate a positive consumer experience.

Another improvement disclosed is a beverage sleeve that is expandable and retractable so that a single sleeve is operable to fit various sized cups. The sleeve may employ an expander feature to permit size adjustment by the consumer at the point of purchase. The expander may be selectively adjustable and have one or multiple folds within the sleeve material so as to allow expansion of the sleeve with the absorption layer continuing to be adjacent to the beverage container. The expander may also utilize a material which could be or not be a pliable adhesive that acts as a hinge to expand the top area of the sleeve. The beverage sleeve may include any number of adjustment pieces having varying sizes and/or shapes.

One such beverage sleeve may include a body, when in an open state, defines an opening through which a beverage container is insertable, the body having a plurality of layers. The plurality of layers may include varying combinations of an external layer, an exterior side of which forms an external face upon which graphics are printable; a coating applied to the external layer either before or after graphic indicia are printed, and an additional coating applied to the interior side of the external layer. The coating may form a water barrier and at least one absorbent layer made of an absorbing material, an internal side of the absorbent layer forming an internal face of the body that is configured to be in contact with the beverage container. The beverage sleeve may or may not also include an adhesive layer joining the absorbent layer on an external side and the coated, internal side of the external layer. The water barrier coating may or may not also act as an adhesive between the absorbent layer and the external layer. These layers are run through a lamination process which converts the individual layers into a single composite material that cannot be separated back into the original layers.

An exemplary process is disclosed for manufacturing a beverage sleeve, such as that described above. Said improved process may include a manufacturing process, such as a lamination process, where the paper substrate and absorbent layer are run through a production process in which a water barrier coating acts as, inter alia, an adhesive during the production process as the materials are laminated into a single composite material. The process may further include cutting at least one beverage sleeve from the single sheet, folding the at least one beverage sleeve; and joining distal ends of the at least one beverage sleeve to a body of the beverage sleeve to define an opening in which a beverage container is insertable. The process may further include manufacturing a sleeve from the single sheet having an expandable gusset. The beverage sleeve may include any number of adjustment pieces having varying sizes and/or shapes. Hence, the sleeve is universal and operable to be utilized with various beverage devices.

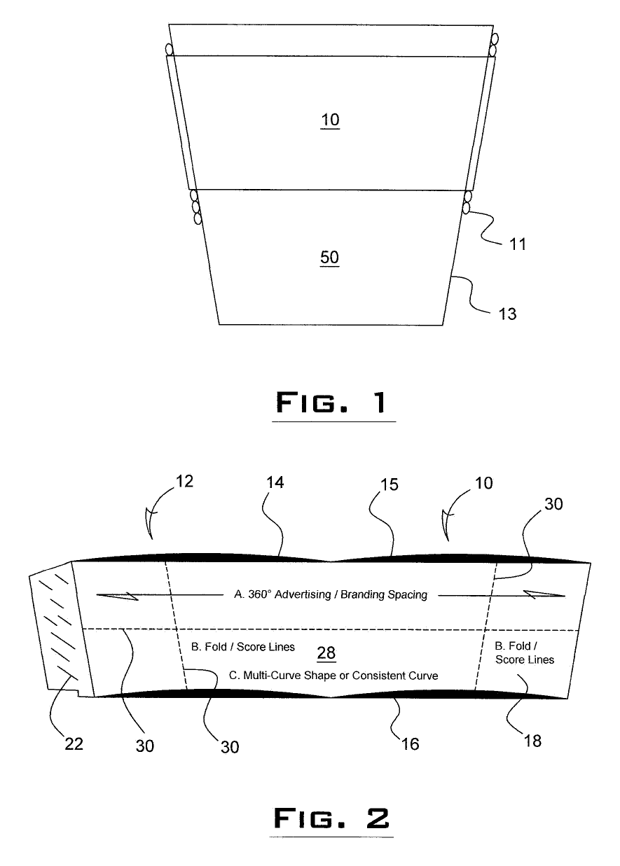

Referring now to the figures, FIG. 1 illustrates a beverage container 50 with a beverage sleeve 10 positioned circumferentially around the beverage container 50. While FIG. 1 depicts the beverage container 50 as a cup, it should be appreciated that the beverage sleeve 10 may be used for most beverage containers, including, but not limited to, bottles, cans, and the like, that may have different shapes, sizes, and/or configurations. In addition, while the beverage container 50 is depicted as having a changing diameter, it should be appreciated that the beverage sleeve 10 may also be used for beverage containers having a constant diameter. It should further be appreciated that the beverage sleeve 10 may be used for beverage containers having any regular or irregular cross-sectional shape, including, but not limited to, circular, hour glass, square, or the like.

The beverage sleeve 10 generally may be configured to be in pressure contact with the beverage container 50 such that the beverage sleeve 10 may absorb condensation 11 formed on an exterior 13 of the beverage container 50, as described in more detail hereinafter, and further so that the beverage sleeve 10 does not slide off of the beverage container 50 when not being held in place by a person holding the beverage container 50. While the beverage sleeve 10 is depicted as being positioned near the top of the beverage container 50, it should be appreciated that it may be positionable at any location along the beverage container, for example, near the bottom where it may absorb condensation 11 that drips from the top of the beverage container 50. It should further be appreciated that the beverage sleeve 10 may be sized and configured to cover substantially the entire surface area of the exterior surface of the beverage container 50.

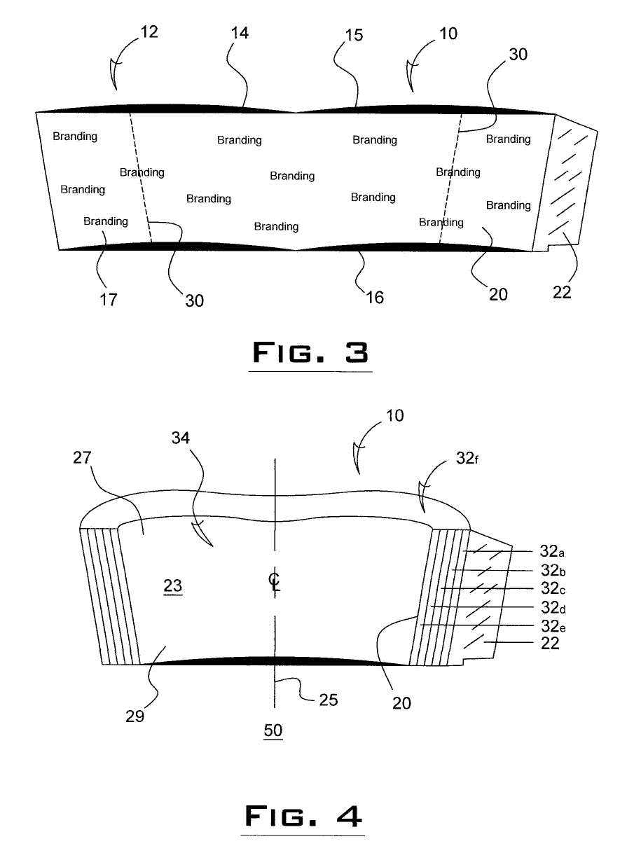

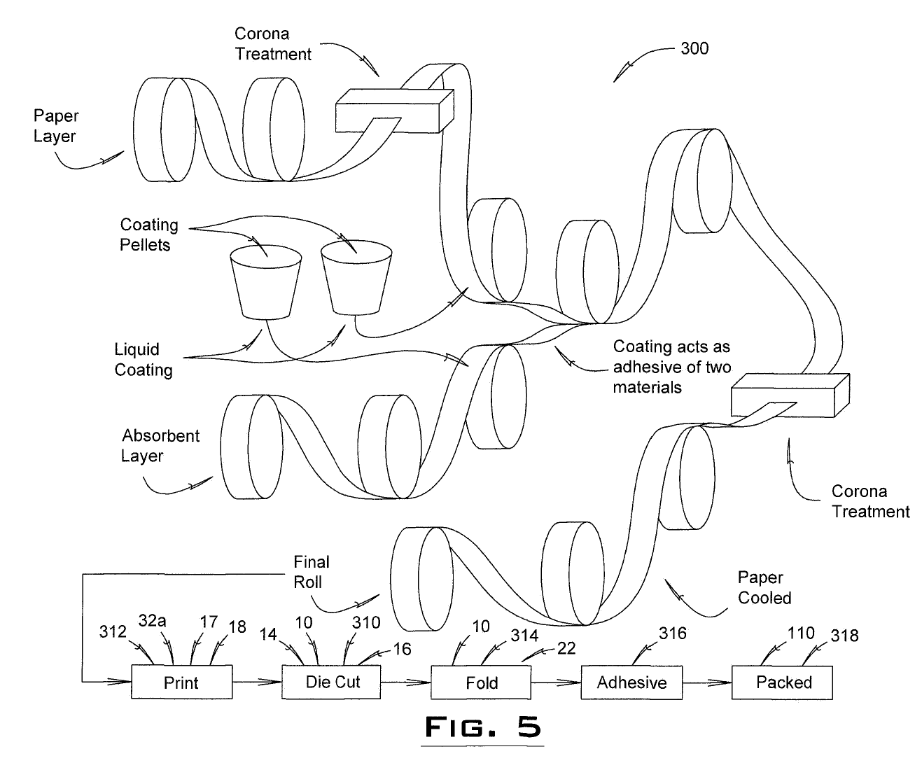

Referring now to FIGS. 2-4, the beverage sleeve 10 generally may include a body 12 that, in an open state, defines an opening 34, as illustrated in FIG. 4, through which the beverage container 50 may be inserted. The body 12 may have a top edge 14 and a bottom edge 16 between which an external face 18 and an internal face 20 are defined. One or both of the top and bottom edges 14 and 16 may or may not have multiple curves 15, which may reduce or minimize the amount of material needed for the body 12, thereby reducing cost as well as the environmental impact of manufacturing the beverage sleeve 10. In addition, one or both of the external face 18 and the internal face 20 may be used for advertising and/or branding.

The novel beverage sleeve 10 may include a series of branding and immediate consumer engagement opportunities 17 on the external face 18 and internal face 20. The branding opportunities 17 may include a brand space 28 located on a surface of the external face 18. A branding opportunity 17 may contemplate designs, words, letters, numbers, graphics, indicia, symbols, patterns, hashtags, QR codes, Touchcodes®, social media, monikers, or any combination thereof. Various materials may be used to implement said opportunities on to the sleeve 10. For example, ink may be used to print the branding opportunities on the sleeve 10. This could include metallized, gravure-like pearl effects, velvet texture, embossed texture effects, light diffraction effects, glitter effects, color shifting, scents (rub & release), black light, phosphorescent (glow-in-the-dark), thermochromic (temperature-controlled color changing inks) polyester, electronic conductive and holographic elements.

Electronic conductive ink is a substance that results in a printed object now having the ability to conduct electricity. This is created by infusing graphite or other conductive materials into the ink. The electronic conductive ink is used to print an invisible code, called a Touchcode on the sleeve. As a beverage is being consumed, the person can touch their sleeve 10 on any touchscreen such as a mobile device or handheld tablet. A customized software application opens and the consumer immediately engages with the branded content which can be a game, form to provide their contact information or join the customer loyalty program. The activation of the application prompts tracking and data collection. Holographic ink is a nanocrystalline ink which is deposited onto microembossed paper with a varnish. The branding elements printed on the holographic beverage sleeve have a high refractive index that can be experienced in all visible ranges of light. As the beverage is consumed and the sleeve 10 and cup are in motion, the holographic branding effects will occur creating a new consumer experience with a beverage sleeve.

The branding opportunity 17 may be located at various locations on the external face 18 and/or internal face 20. A feature of the present disclosure is that the beverage sleeve 10 has a protection feature that protects the branding opportunity 17 from being destroyed, impaired or the like by the condensation 11 that may tend to accumulate on the surface 13 of the beverage container 50. The branding opportunity 17 creates a new channel for consumer engagement, analytics, insights and ROI.

With reference to FIG. 4, the body 12 may be configured such that, in the open state, it defines a set size and/or shape of the opening 34. In such a configuration, the beverage sleeve 10 may be used only for specific beverage containers 50 having size and/or shapes that correspond to those of the opening 34. Alternatively, the beverage sleeve 10 may include at least one adjustment member 22, which could be a fold configuration that is formed as part of the sleeve that permits expansion of the sleeve to varying inside diameters so as to fit beverage containers having various outside diameters. The adjustment member 22 is attached to the body 12 and/or incorporated/formed within the body 12 and it enables a single beverage sleeve 10 to be universal as it can fit different sized and/or shaped beverage containers 50. While the figures depict the beverage sleeve 10 as having only one adjustment piece 22 located at its distal end, it should be appreciated that the beverage sleeve 10 may include any number of adjustment pieces 22 having varying universal sizes and/or shapes. The adjustment piece 22 may or may not be made of a stretchable non-woven material. Additional materials used to adjust the size of the beverage sleeve will perform expansion, memory, and/or recovery properties which are operable to form to different shape and sized beverage containers. In addition or alternatively, the adjustment member 22 may include any other size adjustment devices and/or mechanisms, including, but not limited to, a reappliable adhesive on an end of the body 12, tab(s) on one end of the body 12 and a set of corresponding slots on another end of the body 12, and the like.

With reference to FIGS. 2-3, the body 12 may also include pre-designed perforations, folds or creases 30 that enable the body 12 to be folded or compacted from the open state into a collapsed state, or opened from the collapsed state to the open state without affecting the integrity of the body 12. Such a feature may enable the beverage sleeve 10 to be stacked for high speed packaging and delivery systems. Further, in a retail setting, such as bars, cafes, diners, restaurants, food carts, or wherever else cold drinks may be sold or served, a large number of beverage sleeves 10 in the collapsed state may be placed in a holding container for consumers and/or servers to easily and quickly grab to place on the beverage container 10 before any significant condensation build up may form.

As seen in FIG. 4, the body 12 may include multiple layers 32a-32e. An external layer 32a, which may form the external face 18, may be made of a material that generally is tear and puncture resistant during a normal usage period of consumption of a single serve cold beverage. The material may include, but is not limited to, recycled, bogus, microembossed, reinforced paper, for example, Kraft like paper either coated one-sided or double-sided with calcium carbonate blended poly-resin. Additional substrates may be used as an alternative to Kraft-like paper such as, but not limited to, tree-free synthetic paper, bamboo, reclaimed sugarcane fiber also known as bagasse. The external facing side of the paper may or may not be coated with a co-polymer in the polyethylene family of thermoplastics. The co-polymer could be EMA (ethyl methyl acrylate) or EVA (ethylene vinyl acetate). Co-polymer coatings produce more of a “grip” feel for the consumer experience when holding the sleeve and beverage container. Thus, the sleeve 10 may have an anti-slip or grip feature to assist the consumer to maintain control of the cup 10.

The material also may be bleached or colored white such that it may support full color printing capabilities, for example, advertising and branding as mentioned above. The material may be bleached white through hydrogen peroxide bleaching which is more environmentally friendly than traditional paper bleaching processes. The material may also contain a three-dimensional structure woven mesh or pattern, including, but not limited to, a diamond-like pattern and/or horizontal pattern of 7-pound white poly scrim, on the side of the layer 32a facing the condensation absorption, i.e., opposite the external face 18. Such a structure may aid in maintaining structural integrity of the beverage sleeve 10 during the normal usage period of consumption and condensation absorption. A coating layer 32b may be applied to the reinforced side of the external layer 32a to establish a water barrier. The coating layer 32b may be made of a poly-starch-based or calcium carbonate poly resin. One potential coating that both provides a water barrier and provides an additional layer of protection and gloss to the external printing of graphics that is environmentally friendly is a calcium carbonate poly resin known as EarthCoating®.

The advantages of potentially using a blended polyolefin resin comprised of calcium carbonate and plastic resin provide the following benefits to the converter and consumers of beverage sleeves. First, traditionally 100% polyethylene coatings are poor candidates for repulping due to separating the plastic coating from the paperboard. EarthCoating® can be re-processed throughout the paper recycling stream as if there was no coating at all on the paper. During the paper recycling stream, EarthCoating® fragments into small dense particles that are removed as part of the recycling process. Second, the beverage sleeve 10 can be certified to use the standard recycle symbol due to the properties of EarthCoating® fragmenting during the recycling process. By enhancing recyclability of sleeves, such will reduce the amount of plastic put into the environment. It is estimated that fifty eight billion cups are placed into landfills each year in the U.S. alone and hundreds of thousands of tons of beverage sleeve paper can be recovered resulting in energy savings. Third, the mineralized resin containing calcium carbonate used in EarthCoating® produce a tortuous path for moisture to pass through resulting in better moisture vapor transmission rates (MVTR). Fourth, mineralized resins absorb and dispel heat differently than neat polyolefins, resulting in better heat seal/thermal insulation performance. Five, unlike traditional polyethylene, EarthCoating® provides a high surface energy complete with a typical post-corona dyne level of 4, providing an excellent print surface for high quality graphics. The EarthCoating® may or may not be comprised of 40% calcium carbonate and 60% Low Density Polyethylene. The external and coating layers 32a and 32b may collectively be referred to as the advertising layer.

With continued reference to FIG. 4, an absorbent layer 32d and a top layer 32e may collectively form an absorption layer 32f. The absorbent layer 32d may at least partially include at least one of a thermal bonded airlaid non-woven fabric with cotton, cellulose, pulp, bambasse, bamboo, super absorbent polymers (SAP), and super absorbent fibers (SAF). The thermal bonded airlaid nonwoven materials produce different levels of loft which produce the air pockets that act as a heat transfer barrier. Thus, this construction provides a moisture absorption aspect and a heat transfer aspect, all in one sleeve 10. The resulting sleeve 10 is universal in that it operates to both: 1) reduce moisture runoff from the exterior surface of a container 50 during cold drink uses when condensation often builds up, as well as 2) maintains a cool to the touch exterior surface during hot beverage uses so that the user does not burn its hand when holding the container 50. In other words, the improved universal sleeve 10 is useable for both cold and hot drink uses.

The absorption layer 32f may use bi-component materials as part of the airlaid construction to provide structure to the SAP, SAF, pulp, cellulose and/or cotton. The absorbent layer 32d generally may have an appearance similar to a “web” of fibers, and may or may not be visible to the consumer. An exemplary specification of the fabric with cotton may be: (1) basis weight: 70 g/m2; (2) thickness: 1.05 mm; (3) tensile strength (dry) MD: 1000 g/inch; and (4) absorbent capacity: 12 g/g (2 min). It should be appreciated that such specifications are merely exemplary, and that other specifications may be used depending on other factors, including, but not limited to, the particular use of the beverage sleeve 10, the intended beverage container 50 and the manufacturing process.

In regards to branding opportunities that are visible when looking at the inside surface of the sleeve 10, the airlaid nonwoven material can be run through a production process to emboss the material directly with an image or text for branding on the absorbent layer that lies adjacent to the water barrier and/or adhesive. This production process would occur if the additional layer of the thin absorbent layer 32e is not used in production. The side of the absorbent layer that may be embossed is inside the sleeve, visible to the user as they place the beverage sleeve on their beverage container.

For additional moisture absorption and temperature barrier, the top layer 32e may form the internal face 20 of the beverage sleeve 10. The top layer 32e may be a thin airlaid nonwoven absorbent layer, such as cotton, pulp, cellulose and/or another absorbent material, similar to the absorbent layer 32d described above. The material may be able to be punched, for example by a needle as explained in more detail below, to form larger holes. These holes may allow for the condensation to be quickly drawn through the top layer 32e to the absorbent layer 32d. The absorbent layer 32d and/or the top layer 32e may be sized larger than and wrapped over the other layers 32a-c along the top edge 14, for example by an excess of ¼″.

Alternatively, one sheet of material may be folded over towards an upper or lower surface of the sleeve 10. With the edges of the sleeve folded over the combined layers may be ¼″ thick or more. This may enable the beverage sleeve 10 to absorb larger amounts of condensation toward the top of the beverage container 50, where more condensation may tend to form, for example, when the beverage container 50 holds ice which tends to float on top of the cold beverage. Folding the material and creating a double layer in certain variable performing sections 23 further adds an additional heat transfer barrier. The variable performing sections 23 may be disposed along a longitudinal direction 25 (see arrow in FIG. 4 disposed in an up/down direction), where for example, the top section or portion 27 of the sleeve 10 is designed to include a more absorbent aspect or feature, while the lower section or portion 29 of the sleeve 10 is designed to include a lower absorbent aspect or feature. The variably performing sleeve 10 with its variable heat and moisture absorption performance aspects will accommodate an application where ice sits in the top of container 50, the area likely to yield the most moisture, whereby the absorbent section 27 wicks up moister quicker and more effectively. It will be appreciated that the performance sections 27 and 29 could be inverted with the lower section 29 being more absorbent than the upper section 27. The absorbency rate is measured in ratio of AR=fluid ounces/square inch of cup surface area.

An adhesive layer 32c may be provided to combine or adhere the advertising layer and the absorption layer if the water barrier coating does not act as the adhesive as well. The adhesive layer 32c may be a water resistant adhesive, including, but not limited to, a non-toxic, acid-free, fast track, permanent bond, multi-purpose spray adhesive. The adhesive layer 32c may be used such that it does not bleed through the advertising layer, such that the appearance of any advertising and/or branding on the external face 18 may be maintained. Both the water barrier coating and water resistant adhesive may be used to strengthen moisture vapor transition rates.

It should be appreciated that the body 12 may include additional layers not described herein. The resulting beverage sleeve 10 has a sandwich construction with a moisture barrier portion that precludes impairment of the indicia 17 on the beverage sleeve 10, yet absorbs moisture 11 and slows down the transfer of heat adjacent the surface 13 of the beverage container 50. This construction minimizes and/or eliminates the pooling of condensation that typically occurs on the side and at the base of the cold beverage container 50, particularly on warm days with high humidity.

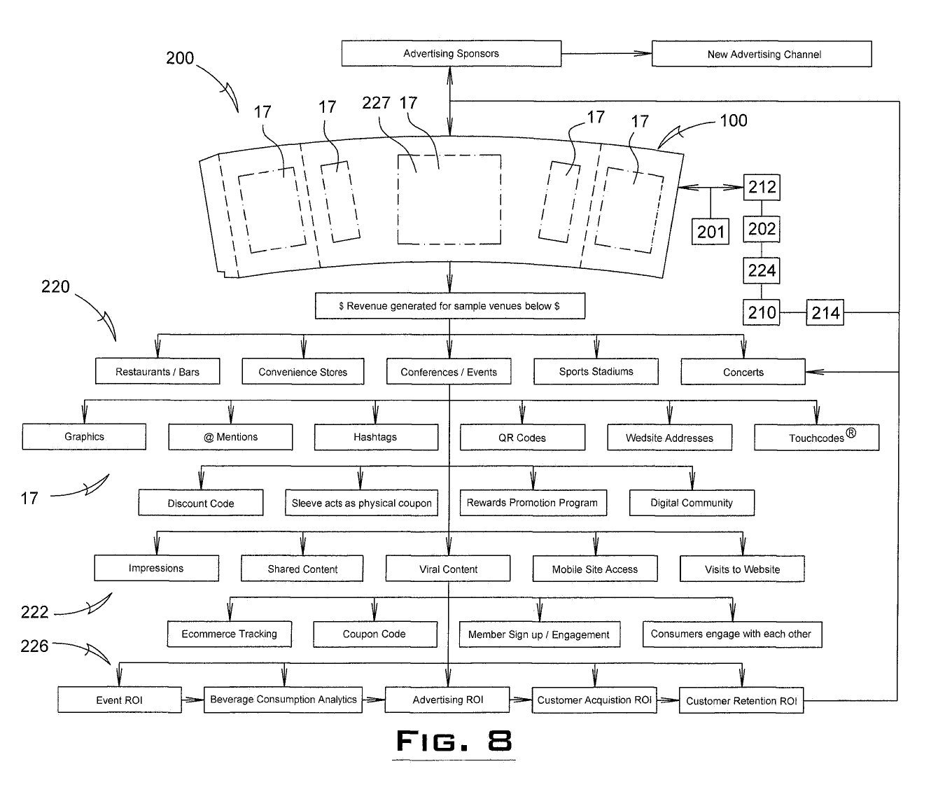

FIGS. 6 and 7 illustrate an alternative sleeve 100 employing some of the similar construction characteristics of sleeve 10, but now with an improved expansion member 110. One exemplary embodiment employs a sleeve that has distal ends of the sleeve folded in an accordion style during the diecut and conversion process. Small amounts of a weak adhesive are added to the accordion folds that will break upon pressure of insertion of a beverage container. The adhesive is also placed on the external layer and when folded pressed together. The accordion material is tightly folded and is positioned inside the sleeve.

In another embodiment, the expansion member 110 may be unitary with a body 112 of the sleeve 100, or it could be a separate component. The body 112 of the sleeve 100 includes a layered construction, which become one, unified layer during the lamination process, having potentially similar layers as disclosed in the sleeve 10 described herein. Alternatively, the sleeve 100 may include a body 112 having an advertising layer 114, an adhesive/water and heatbarrier layer 116, and possibly an attachment feature 118, and an expandable member 120.

With reference to FIG. 7, the attachment feature 118 could be fixed to one or more portions or sides of the body 112 and it may be integrally formed as part of the body 112. A purpose of the attachment feature is to provide a transition between the body 112 and the expandable member 120. The expandable member 120 could consist of its own transition portion and connect directly to the body 112 of the sleeve 100. The expandable member 120 may also be an extension of the finished material beyond a standard beverage sleeve dimension. In the exemplary illustrations presented, the expandable member 120 may have a series of pleats 122 offset from one another extending in a direction normal to the longitudinal axis 25. The pleats 122 have an inner portion 124 and an outer portion 126. The inner portion pleat 124 is part of or engages with the attachment member 118 in a secure form. This secured arrangement assures the expandable member 120 maintains connection with the body 112. The pleats 122 may be temporarily secured to one another by the application of a non-permanent substance 128 such as an adhesive. The substance 128 does not permanently secure each such pleat together but instead provides a method for a user to selectively expand the sleeve's circumference at the point of purchase. This is accomplished by sliding a container 50 inside sleeve 100 so as to cause outward expansion of the sleeve 100. The sleeve continues to outwardly expand until the outside diameter of the container 50 fully engages an inside diameter 130 of the sleeve. At this point the sleeve stops expanding and it rests.

The non-permanent substance, such as but not limited to a low contact adhesive, 128 may be applied in varying amounts on each pleat 124 so as to vary performance of the expansion member 110. For example, the pleat 124 located towards the center of the sleeve 100 may employ 5 or so units of substance 128. This would cause the adjoining sleeve to tend to not release so easily. By contrast the pleat 126 located at the outer portion of the expandable member 110, may only have two or so units of non-permanent substance 128. This arrangement would cause the pleat adjacent thereto to release more quickly as the consumer slides the container 50 within the sleeve 110. Correspondingly, the pleats between the inner pleat 124 and the outer pleat 126 may have varying amounts of adhesive located on their surface, as is shown in FIG. 7. This construction provides an expandable member 110 that expands or releases outwardly in a controlled manner so as to allow enhanced tight grip of the sleeve relative to the container 50. Such prevents a sleeve from inadvertently expanding too quickly or too much which if that occurs, the sleeve 110 may not properly grip around the circumference of the container 50. Thus, the sleeve 100 has an expansion control feature 110′ which, in part is accomplished by the collection of the arrangement of a plurality of pleats, adjacently aligned, each of which having a desired amount of a substance 128. The sleeve thus has a selectively adjustable expansion feature that may be consumer controlled at a point of purchase.

### New Channel Consumer Sleeve System

FIG. 8 illustrates a system 200 for a new channel for Consumer Engagement, Analytics, Insights and ROI. The channel is created through the advanced ink and printing capabilities on a beverage sleeve 10 which prompts a consumer to experience branding elements in new methods such as using their mobile device to touch the ink on the beverage sleeve 10 to activate a digital experience or placing their beverage under a black light for branding elements to display such as a winning contest number to enter into a mobile application. The system 200 employs the unique aspects of the sleeves 10, 110, along with opportunities revealed through utilization of the sleeves as a revolutionary consumer engagement tool 201. The tool 201 will result in generating consumer data 210, by consumers 212 engaging an experience with the sleeves 10, 100. The data 210 is collected on a server 214 having a computer, computer code, and data storage, which in turns processes algorithms that manipulates, and provides analytics and insights about consumer behavior. This in turn generates trackable ROI to companies and meaningful intelligence.

The schematic of FIG. 7 illustrates one exemplary system 200, including a sleeve 10, 100, that a consumer 212 may engage with as he or she purchases a cup of coffee from a retail outlet or other venue 220. It will be appreciated that the system 200 may be employed for other beverages. The sleeve contains indicia 17 that a consumer 212 will associate with the venue 220 during the time the beverage is consumed. As the consumer 212 partakes of the beverage during the relevant time period, commercial impressions and social media experiences will occur 222. This may transpire by the consumer 202 engaging devices such as a mobile device 202 to send messages, inquire about coupons, and the like. Those messages 224 are transmitted as data packets 210 to a server 214. The server 214 is operable to compute via code, storage medium and processors, and create output such as intelligence 226, i.e., ROI and analytics.

Companies are always looking for new vehicles to advertise, increase brand awareness and engage with both prospects and clients. On the flip side, companies are interested in selling advertising spots to generate increased revenue streams. For example, college sporting teams need revenue to fund their programs and make improvements. Event personnel want to sell more sponsorships to increase event revenue. Beer and liquor companies want to have their brands visible to consumers that are at the restaurant. Business Partners of Professional Stadiums such as a credit card company or businesses in the city where the stadium is located want to advertise and get their brands in front of the local community. Companies that sponsor business conferences that want brand visibility when competing with other event sponsors and trying to get attention. These conferences can last up to a week with beverages being served 15 hours a day to 175,000 attendees. Music artists want to share their upcoming tour dates, concert goers to follow them on Instagram and Twitter that are attending the concert that night.

The water absorbent heat barrier beverage sleeves 10 and 100 offer 360 degree advertising on both the external and internal layer of the sleeve. Impressions 222 of the ads 17 can be calculated of the number of attendees at an event plus the average impressions people see as they view another holding a beverage with a sleeve. When consumers have repeat impressions of the same content or images, they retain and remember the content or images at higher rates. While there is the physical sleeve generating visual impressions and also serves as a solution to a common problem of your hand getting too cold, hot, and/or wet when holding a container—there is also the engagement opportunity with the content and graphics 17 on the beverage sleeve 100. The content and images can prompt a consumer to engage digitally with the brand, they can engage with fellow consumers in community, polls can be taken on mobile phones, consumers can immediately follow on twitter or post a photo of the event via mobile phones, they can take the physical sleeve into a retail store, restaurant, convenience store and the cashier can redeem the coupon and enter in a coupon code. Content can be shared exponentially with hashtags 17 and @ sign mentions on social media. Touchcodes® printed with electronic conductive ink can tell consumers to touch their phone on the sleeve and activate a mobile app. Glow-in-the-dark ink also known as phosphorescent ink can increase brand visibility at sporting events, concerts, festivals conferences and similar-type events. For example, all beverages at the SuperBowl that are served include a sleeve with phosphorescent ink. When sports fans walk under black lights stationed throughout the stadium, branding illuminates indicating if a fan has won a prize, receive a free beverage or are directed to the next black light station creating a multi-phased experience.

New customers can be acquired and also existing customers retained. School events can have parents, students and faculty engage with each other by seeing the digital opportunities on the sleeves. Rewards programs can acquire new members or members can engage and move up to the next level.

Consumers can join digital communities for long-term engagement with loyal consumers generating “raving fans” of their brand. This turns into a brand ambassador program where the fans give input to the company to improve products and services.

All of this engagement data collected 210 in software as a service platform such as Google Analytics, SAS and other business intelligence platforms, results in analytics that can be analyzed into valuable insight from a new advertising channel that did not exist. Tracking and engagement does not exist on Napkins and Coasters today. This analysis provides big data 210 on the success of the campaigns, delivers insights on future campaign enhancements, consumers engage, leads are generated and post content that can be analyzed to gain a deeper understanding of the demographics and psychographics of the consumer base that attended an event, ate at a restaurant or went to a professional football game. For example, brands that fight to run SuperBowl ads now have a new advertising venue that will generate millions in advertising dollars. The impressions and visibility lasts for hours during the game and multiple beverages are often consumed with the ability to rotate and have multiple advertisers either on one sleeve or sleeves dedicated to one brand but the different brands are rotated throughout the games.

This system 200 generates deeper insight into events and venues never delivered before back to companies, schools, colleges, universities, loyal sports fan bases that want to reach these audiences. They better understand who their fans are, who is delighted and why, and who is not delighted and why.

This cycle happens for every game, concert, evening at a restaurant, conference and annual event. The data builds over time in analytic software platforms showing trends in consumer behavior and revenue generated post event in incremental sales. This trend data gives companies the ability to predict and automate additional advertising campaigns pre and post event. As email addresses and contact information is collected on the company's websites, social media properties and the like—companies are building their contact databases once the consumer opts in to receive communications.

New “tags” in analytics systems will be developed to track if the referral source of a user visiting a site or mobile landing page from a Touchcode code for example is from a beverage sleeve.

### Production Process

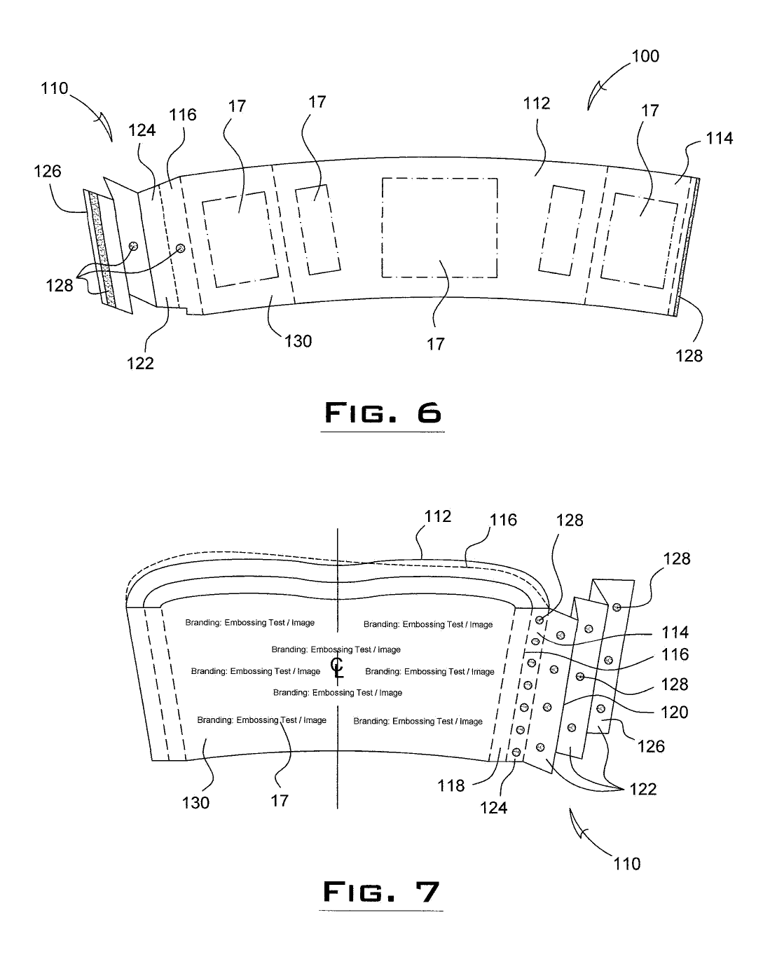

An improved finished roll production process 100 is disclosed. See FIG. 5. Two separate rolls of material which may be one roll of paper or similar substrate and one roll of airlaid nonwoven are loaded into the extrusion lamination machine. They are unwound at the unwinding station and rolled through a scanner for thickness measurement; the paper may or may not run through 2 to 4 color printing process because printing can occur during the finished roll production or at the time the finished roll is going through the beverage sleeve die cutting and folding process. If printing of graphics and text is applied during the lamination process producing the finished rolls, or once the paper roll is unwound onto moving cylinders, the paper goes through a corona treatment in preparation for mono or co-extrusion. Corona treatment is a high frequency discharge that increases the adhesion of a plastic surface. Whether a liquid wets a material good or poorly depends primarily on the chemical nature of both the liquid and substrate. Wetting is defined as the ratio between the surface energies of the liquid and substrate. In other words, the paper is pre-heated to open the fibers of the paper prior to extrusion of the coating and lamination process.

Next pellets of the water barrier coating, which may also act as an adhesive, are placed in a hopper where the pellets are fed, melted, metered and mixed if there are multiple coatings combined from multiple hoppers; it is then extruded at 550-600 degrees Fahrenheit onto the paper or alternate substrate.

Next the absorbent layer is then merged with the paper and the coating acts as the adhesive to adhere two separate materials into one finished roll. The paper then goes through an instant cooling process where the material is wound into a finished roll and moves on to one of two potential steps. (1) The paper is unwound to expose the other side of the paper to apply a LDPE, polyethylene, starch-based, EMA or EVA coating to the side of the paper that is printed to seal the printing already done during the lamination process. Or, it is coated using one of the aforementioned types of coatings in preparation for beverage sleeve converters to print and convert the finished roll into sleeves in hi speed production lines.

Referring to FIG. 5, an improved manufacturing process 300 includes processing at least one expansion member 110 from the single sheet so that it is part of the stock for the sleeve. At step 310, the beverage sleeves 10 may be cut into the desired shape, including but not limited to the multi-curved, straight or single curved top layer 14 and/or bottom layer 16, and size. At step 312, graphics 17 for advertising and/or branding purposes may be printed on the non-structural side of the external layer 32a, i.e., the external face 18. If no graphics are to be printed, for example, if the beverage sleeves 10 are sold as blank slates to promotional companies, distributors, vendors, and the like, for their own in-house printing, process 300 may skip step 312 and proceed directly to steps 314 and 316 at which the sleeves are folded and the ends are joined. Where the beverage sleeve includes the attachment piece 22, this may include joining an end of the attachment piece 22 with the free end of the sleeve.

Joining of the ends may be achieved by any adhesive, including, but not limited to, glue, tape, water-activated tape and the like, or any other attachment mechanism or devices, including, but not limited to, staples, stitching, corresponding tabs and slots, and the like. It may also include a folding process during the conversion process where one of the ends of a sleeve is folded approximately ½ inch in width adhesive applied only to the edge of the folded portion. At step 318, the resulting beverage sleeves, in their collapsed states, may be packaged for shipping. This may be done manually or automatically. Process 300 may end after step 318.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

It will be appreciated that the aforementioned method and devices may be modified to have some components and steps removed, or may have additional components and steps added, all of which are deemed to be within the spirit of the present disclosure. Even though the present disclosure has been described in detail with reference to specific embodiments, it will be appreciated that the various modifications and changes can be made to these embodiments without departing from the scope of the present disclosure as set forth in the claims. The specification and the drawings are to be regarded as an illustrative thought instead of merely restrictive thought.

All terms used in the claims are intended to be given their broadest reasonable constructions and their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

What is claimed is:

1. A beverage sleeve comprising:
a body, having an opening through which a beverage container is insertable, the body having a plurality of layers which are laminated into a unified construction, the body including at least:
an external layer having an exterior side, said exterior side having an external face upon which graphics may be printed thereon, the external layer further having an interior side;
a coating applied to an interior side of the external layer, the coating forming a water barrier, the coating having an adhesive feature;
at least one absorbent layer made of an absorbing material, the at least one absorbent layer having an internal face that is configured to in contact with a beverage container; and
an adhesive layer joining the at least one absorbent layer on the external side and the coated, internal side of the external layer.

2. The beverage sleeve of claim 1, further comprising an adjustment member that is selectively configurable to receive beverage containers of different sizes.

3. The beverage sleeve of claim 1, wherein the material includes at least two perforations, folds or creases such that the beverage sleeve is collapsible into a collapsed state.

4. The beverage sleeve of claim 1, wherein at least one of a top edge and a bottom edge of the body has a curved shape that includes a single or multi-curve shape.

5. The beverage sleeve of claim 1, wherein the at least one absorbent layer includes a top layer and an absorbent layer, the top layer being positioned radially inward of the absorbent layer.

6. The beverage sleeve of claim 5, wherein a portion of at least one of the top layer and the absorbent layer is foldable over the other layers of the body.

7. The beverage sleeve of claim 5, wherein the top layer includes a plurality of holes on the internal side to allow condensation forming on an exterior surface of a beverage container to pass through the top layer to the absorbent layer.

8. A process comprising:
forming a first roll of an advertising layer;
forming a second roll of an absorption layer;
joining the first roll and the second roll via an adhesive layer to form a single sheet;
cutting at least one beverage sleeve from the single sheet;
folding the at least one beverage sleeve such that a side of the advertising layer forms an external face of the at least one beverage sleeve; and
joining distal ends of the at least one beverage sleeve to a body of the beverage sleeve to define an opening in which a beverage container is insertable.

9. The process of claim 8, wherein cutting the at least one beverage sleeve includes cutting at least one of a top edge and a bottom edge of the body of the beverage sleeve to have at least one of a single or multi-curved shape.

10. The process of claim 8, wherein forming the first roll includes a coating a layer of material to form a water barrier.

11. The process of claim 8, further comprising attaching at least one adjustment piece to an end of the single sheet.

12. The process of claim 11, wherein joining the distal ends of the at last one beverage sleeve includes joining one of the distal ends with the at least one adjustment piece.

13. The process of claim 8, further comprising printing at least one graphic on an external face of the body of the at least one beverage sleeve.

14. The process of claim 8, further comprising folding a portion of the absorption layer over an edge of the advertising layer or both layers.

15. The process of claim 8, further comprising printing an indicia on the sleeve utilizing a touchcode process.

16. A beverage sleeve comprising:
a body having a first side and a second side;
a panel formed as part of the body, said panel is located on an outer surface of said panel;
advertising indicia located on the outer surface of said panel; and
a system for a consumer to engage the advertising indicia.

17. The beverage system as claimed in claim 16, wherein the sleeve is reusable.

18. The beverage sleeve as claimed in claim 16, further wherein said system includes a network with data for a company to learn intelligence about consumer behavior.

19. The beverage sleeve as claimed in claim 16, further comprising invisible ink that is heat sensitive.

20. The beverage sleeve as claimed in claim 16, further comprising electronic conductive ink
